(19) United States
(12) Patent Application Publication
(10) Pub. No.: US 2022/0267124 A1
(43) Pub. Date: Aug. 25, 2022

(54) TerraPull Device

(71) Applicant: David Sizer, Richardson, TX (US)

(72) Inventor: David Sizer, Richardson, TX (US)

(21) Appl. No.: 17/181,384

(22) Filed: Feb. 22, 2021

(51) Int. Cl. B66D 3/14

(52) U.S. Cl. CPC B66D 3/14; B66D 2700/0116

(57) ABSTRACT

An article of manufacture for providing an earth extraction device provides a set of three posts, a post securing bolt having a threaded end and a fix end and passing through the first top hole and the second top hole of each of the three posts in consecutive order for coupling the set of three posts together at a coupling point, a mating nut for coupling to the threaded end of the post securing bolt after protruding through the second top hole of the third post, a block and tackle pully-and-winch, and a top chain having a first end and a second end, the top chain configured around each of the posts of the set of three post above the coupling point. The block and tackle pully-and-winch includes a hook coupled to a top end, a winch cable configured within the pully and winch; a bottom chain coupled to a bottom end, and a winch handle, the winch handle configured to rotate the winch causing the winch cable within the block and tackle to shorten with an upward stroke. The first end and the second end of the top chain engaging the hook to suspend the pully and winch below the coupling point of the set of three posts.

### TECHNICAL FIELD

This application relates in general to an article of manufacture for providing a lifting device, and more specifically, to an article of manufacture for providing an earth extraction device.

### BACKGROUND

Both commercial landscapers and property owners often have the need to remove items buried in the earth, especially tree roots and stumps. Often, it's a single individual performing the extraction, and as such, this person does not have the strength to remove the item alone.

Therefore, a need exists for an article of manufacture for providing an earth extraction device. The present invention attempts to address the limitations and deficiencies in prior solutions according to the principles and example embodiments disclosed herein.

### SUMMARY

In accordance with the present invention, the above and other problems are solved by providing an article of manufacture for an earth extraction device according to the principles and example embodiments disclosed herein.

In one embodiment, the present invention is an article of manufacture for providing an earth extraction device. An article of manufacture for providing an earth extraction device provides a set of three posts, a post securing bolt having a threaded end and a fix end and passing through the first top hole and the second top hole of each of the three posts in consecutive order for coupling the set of three posts together at a coupling point, a mating nut for coupling to the threaded end of the post securing bolt after protruding through the second top hole of the third post, a block and tackle pully-and-winch, and a top chain having a first end and a second end, the top chain configured around each of the posts of the set of three post above the coupling point. The block and tackle pully-and-winch includes a hook coupled to a top end, a winch cable configured within the pully and winch; a bottom chain coupled to a bottom end, and a winch handle, the winch handle configured to rotate the winch causing the winch cable within the block and tackle to shorten with an upward stroke. The first end and the second end of the top chain engaging the hook to suspend the pully and winch below the coupling point of the set of three posts.

In another aspect of the present disclosure, each of the post within the set of three posts further includes a short length of foot plate chain within the bottom end of each of the three posts for securing each foot plate to the bottom end of each post, a first bottom hole and a second bottom hole about the bottom end and located on opposing sides of each post, a first foot bolt and a first foot nut, a foot plate coupled to the bottom end of each of the three posts having a center hole, and a second foot bolt and a second foot nut. The second foot bolt passes through the center hole of the foot plate and a bottom link in the short length of foot plate chain exposing a threaded end for coupling with the second foot nut. The first foot bolt passes through the first bottom hole, a top link in the short length of foot plate chain, and the second bottom hole exposing a threaded end for coupling with the first foot nut.

In another aspect of the present disclosure, the post securing bolt comprises a first and second bend between the fixed end and the threaded end, the first bend having an angle of 13 degrees—36′, being located 2 ⅛″ from a fixed end of the post securing bolt and the second bend having an angle of 11 degrees—33′ being located 2/3/4″ further along the post securing bolt from the first bend.

In another aspect of the present disclosure, the post securing bolt is a ½″−13×8″ bolt.

In another aspect of the present disclosure, the bottom chain being configured to attach to an item to be extracted.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture for providing an earth extraction device according to the present invention.

FIG. 2 illustrates another view of an article of manufacture for providing an earth extraction device according to the present invention.

FIG. 3 illustrates two holes through the posts permitting a post securing bolt and a first bolt a to be placed into the posts according to the present invention.

FIG. 4 illustrate components within an article of manufacture for providing an earth extraction device and its components according to the present invention.

### DETAILED DESCRIPTION

This application relates in general to an article of manufacture for providing a lifting device, and more specifically, to an article of manufacture for providing an earth extraction device according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “worker,” and “user” refer to an entity, e.g., a human, using the earth extraction device associated with the invention. The term user herein refers to one or more users.

The term “invention” or “present invention” refers to the invention being applied for via the patent application with the title “TerraPull Device.” Invention may be used interchangeably with device.

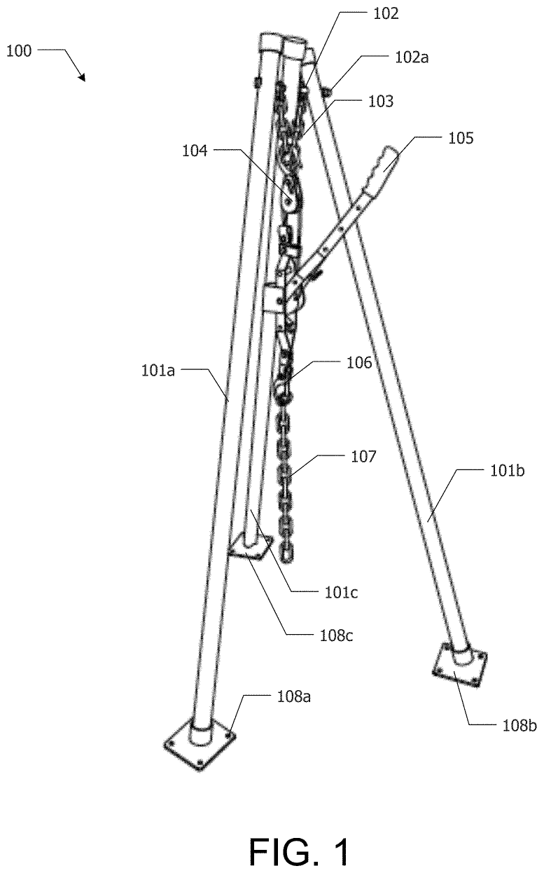

In general, the present disclosure relates to an article of manufacture for providing a lifting device. To better understand the present invention, FIG. 1 illustrates an example embodiment of an article of manufacture providing an earth extraction device according to the present invention. The earth extraction device 100 is used to secure a chain 107 about an object buried within the earth and attempts to extract the item by pulling from above. The earth extraction device 100 is constructed using a trio of posts 101a-c that are coupled together at a top end of each of the posts 101a-c using a post-securing bolt 102. The post-securing bolt 102 passes through each of the posts 101a-c and is secured using a nut 102a.

A chain 103 is wrapped around a center of the three posts 101a-c above the coupling point created by the post securing bolt 102. Each end of the chain 103 is secured to a hook 104a coupled to a top end of a pulley-and-winch 104. The pulley-and-winch 104 hangs downward from the chain 103 between the three posts 101a-c once they have been extended outward in opposite directions to create a three-legged support structure. The pulley-and-winch 104 is operated by a winch handle 105 that winds the cable arranged around the pulleys in which multiple parallel loops of the cable are used to multiply the force exerted upon the winch handle 105. A second chain hook 206 is coupled to the bottom end of the pulley-and-winch 104 that permits a chain 107 to be attached.

The chain 107 may be wrapped around a buried object and then both of its ends may be secured to the chain hook 106. As the pulley-and-winch 104 rises as the cable within the pulleys is shortened, the chain 107 also is pulled upward extracting the object from the earth. The block and tackle pulley-and-winch 104 generates significantly more upward force when a worker is pulling down on the winch handle 105. Each stroke exerted upon the winch handle 105 shortens the cable within the block and tackle pulley-and-winch 104 and thus pulls upward on its bottom end with a multiple amount of force. This increase in force created by the block and tackle pulley-and-winch 104 is sufficient to extract most items from a buried location.

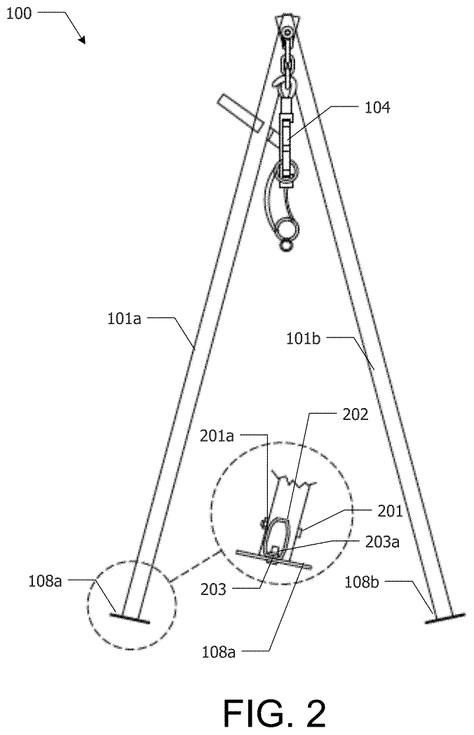

A set of foot plates 108a-c is coupled to the lower ends of the trio of posts 101a-c to widen their contact with the ground and reduce any possibility that the pulley-and-winch 104 may be pulled into the ground rather than extracting the buried item from the earth. The foot plates 108a-c are secured to the bottom of the posts 101a-c as disclosed below in reference to FIG. 2.

FIG. 2 illustrates another view of an article of manufacture for providing an earth extraction device according to the present invention. FIG. 2 shows part of the earth extraction device 100 that includes just two of the three posts 101a-c. The pulley-and-winch 104 is shown hanging from the top of the device as described above. A detail section 200 shows the components within each of the three posts 101a-c that are used to secure the foot plates 108a-c to the bottom of the three posts 101a-c.

A first foot bolt 201 passes through each of the posts 101a-c about the bottom end of each of the posts 101a-c. The first foot bolt 201 is secured by a first foot nut 201a. A short length of foot plate chain 202, which may be a single link from a chain, is coupled to a second foot bolt 203 that passes through each of the foot plates 108a-c to be secured by a second foot nut 203a. The first foot bolt 201 is passed through the chain 202 as the first bolt 201 is passed through the posts 101a-c. When the second nut 203a secures the chain 202 and second bolt 203 to the foot plates 108a-c, the chain 202 connects the first foot bolt 201 to the second foot bolt 203, and thus to the foot plates 108a-c. This arrangement of components keeps the foot plates 108a-c securely attached to the bottom end of the posts 101a-c.

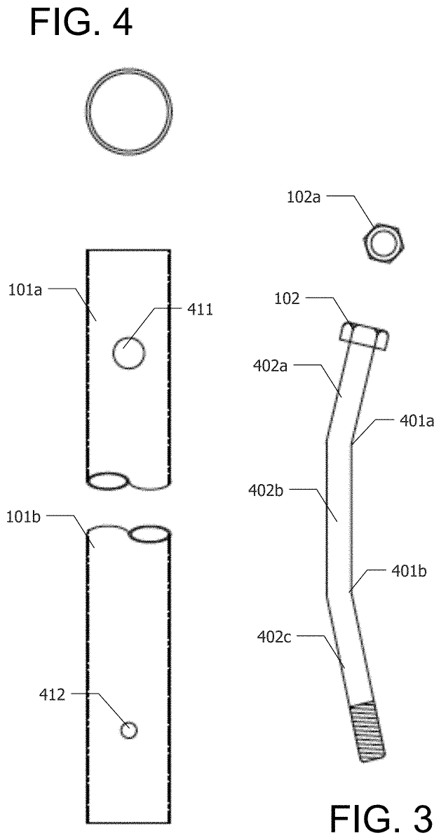

FIG. 3 illustrates two holes through the posts 101a-c that permit the post securing bolt 102 and the first foot bolt 201 to be placed into the posts 101a-c. The post securing bolt 102 is a ½″−13×8″ bolt in a preferred embodiment. The post securing bolt 102 engages a first 9/16″ diameter hole 411 through the posts 101a-c. The first bend 401a, defined as having an angle of 13 degrees—36′, is located 2 ⅛″ from a fixed end of the post securing bolt 102 while bending ½ from its centerline. The second bend 401b, defined as having an angle of 11 degrees—33′. is located 2/3/4″ further along the post securing bolt 102 from the first bend 401a. The third segment 402c is measured from the second bend location 401b to the end of the 8″ bolt. The second bend creates a bend of ⅝″ from the centerline when measured from the second bend location 401b to the threaded end of post securing bolt 102.

The first foot bolt 201 engages a second 9/32″ hole 412 about the lower end of the posts 101a-c. These holes 411-412 are placed 180° apart on opposite sides of the posts 101a-c.

FIGS. 4 illustrate components within an article of manufacture for providing an earth extraction device and its components presented according to the present invention. FIG. 4 shows the post securing bolt 102 along with its mating nut 102a. The post securing bolt 102 is divided into three segments 402a-c that are created by bends 401a and 401b. Each segment 402a-c is long enough to allow each of the posts 101a-c to be connected along post securing bolts 102 when the posts 101a-c are coupled together. The three posts 101a-c are each placed onto the post securing bolt 102 at holes about the upper end of the posts 101a-c. The bends 401a-b permit the posts 101a-c to be oriented in the middle of each of the segments 402a-c while the posts 101a-c are positioned outward from the center of the earth extraction device 100 when the device is in use.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing an earth extraction device, the article comprises:
a set of three posts, each post comprising:
a top end;
a bottom end; and
a first top hole and a second top hole about the top end and located on opposing sides of each post;
a post securing bolt having a threaded end and a fix end and passing through the first top hole and the second top hole of each of the three posts in consecutive order for coupling the set of three posts together at a coupling point, the fix end of the post securing bolt being positioned adjacent to the first top hole of a first post of the set of three posts and the threaded end protruding outward from the second top hole of a third post of the set of three posts;
a mating nut for coupling to the threaded end of the post securing bolt after protruding through the second top hole of the third post;
a top chain having a first end and a second end, the top chain configured around each of the posts of the set of three post above the coupling point; and
a block and tackle pully-and-winch comprising:
a hook coupled to a top end, the first end and the second end of the top chain engaging the hook to suspend the pully and winch below the coupling point of the set of three posts;
a winch cable configured within the pully and winch;
a bottom chain coupled to a bottom end; and
a winch handle, the winch handle configured to rotate the winch causing the winch cable within the block and tackle to shorten with an upward stroke.

2. The article of manufacture of manufacture according to claim 1, wherein each of the post within the set of three posts further comprises:
a short length of foot plate chain within the bottom end of each of the three posts for securing each foot plate to the bottom end of each post;
a first bottom hole and a second bottom hole about the bottom end and located on opposing sides of each post;
a first foot bolt and a first foot nut, the first foot bolt passes through the first bottom hole, a top link in the short length of foot plate chain, and the second bottom hole exposing a threaded end for coupling with the first foot nut;
a foot plate coupled to the bottom end of each of the three posts, the foot plate having a center hole; and
a second foot bolt and a second foot nut, the second foot bolt passes through the center hole of the foot plate and a bottom link in the short length of foot plate chain exposing a threaded end for coupling with the second foot nut.

3. The article of manufacture of manufacture according to claim 1, wherein the post securing bolt comprises a first and second bend between the fixed end and the threaded end, the first bend having an angle of 13 degrees—36′, being located 2 ⅛″ from a fixed end of the post securing bolt and the second bend having an angle of 11 degrees—33′ being located 2/3/4″ further along the post securing bolt from the first bend.

4. The article of manufacture of manufacture according to claim 3, wherein the post securing bolt is a ½″−13×8″ bolt.

5. The article of manufacture of manufacture according to claim 3, wherein the bottom chain being configured to attach to an item to be extracted.
